(19) United States
(12) Patent Application Publication
(10) Pub. No.: US 2015/0307767 A1
(43) Pub. Date: Oct. 29, 2015

(54) METHOD FOR INHIBITING GAS HYDRATE BY NON-CORROSIVE QUATERNARY AMMONIUM COMPOUNDS

(71) Applicant: LAMBERTI SpA, Albizzate (Varese) (IT)

(72) Inventors: Andrea BALESTRINI, Albizzate (Varese) (IT); Lorenzo GIARDINI, Albizzate (Varese) (IT); Mauro PARINI, Albizzate (Varese) (IT); Giuseppe LI BASSI, Gavirate (Varese) (IT); Giovanni FLORIDI, Novara (IT)

(73) Assignee: LAMBERTI SpA, Albizzate (Varese) (IT)

(21) Appl. No.: 14/697,160

(22) Filed: Apr. 27, 2015

Related U.S. Application Data
(60) Provisional application No. 61/984,126, filed on Apr. 25, 2014.

(51) Int. Cl. C09K 8/52

(52) U.S. Cl. CPC C09K 8/52; C09K 2208/22

(57) ABSTRACT

The formation of hydrocarbon hydrates can be inhibited or mitigated by contacting a a mixture comprising water and hydrate-forming guest molecules under gas hydrate forming conditions with a quaternary ammonium hydroxide QOH or a quaternary ammonium compound QA, in which A is not a halogen atom. The QOH or QA may be prepared reacting a quaternary ammonium halide QX with a metal hydroxide M(OH)ₓ, or with a metal salt MA, in an alcohol solvent to form a quaternary ammonium hydroxide QOH, or a quaternary ammonium compound of formula QA, and metal halide MX. Optionally, the quaternary ammonium hydroxide QOH may be reacted with an organic or inorganic acid AH which is different from a hydrogen halide to form the quaternary ammonium compound QA. The metal halide MX may be removed by phase separation after addition of water or of a water/solvent mixture, or by filtration.

### CROSS REFERENCE TO RELATED APPLICATIONS

This Application claims priority from U.S. provisional patent application having the Application No. 61/984,126 which was filed on Apr. 25, 2014, and which is incorporated herein by reference in its entirety.

### BACKGROUND OF THE INVENTION

1. Field of the Invention

This disclosure relates to a method for inhibiting gas hydrates formation in oil and gas conduits. This disclosure particularly relates to the use of non-corrosive quaternary ammonium compounds obtained from quaternary ammonium halides as hydrate inhibitors.

2. Background of the Invention

Gas hydrates (or clathrate hydrates, gas clathrates, clathrates, etc.) are crystalline water-based solids physically resembling ice, in which small non-polar hydrocarbon molecules (typically gases) are trapped inside “cages” of hydrogen bonded water molecules. In other words, gas hydrates are clathrate compounds in which the host molecule is water and the guest molecule is typically a hydrocarbon gas.

Gas hydrates cause problems for the petroleum industry because they can form inside gas pipelines. Since they have a strong tendency to agglomerate and to adhere to the pipeline walls, the formation of gas hydrates may even result in obstructions of the pipelines. Preventing gas hydrate formation is therefore desirable in the art of producing and transporting natural gas.

One method to control the growth of gas hydrates is by employing chemicals that can lower the hydrate formation temperature and/or delay their formation (gas hydrate inhibitors). Different kinds of gas hydrate inhibitors exist: thermodynamic inhibitors and kinetic inhibitors/anti-agglomerants. The most common thermodynamic inhibitors are lower alkyl alcohols and glycols. Kinetic inhibitors and anti-agglomerants are also known as Low-Dosage-Hydrate-Inhibitors (LDHI), because they require much smaller concentrations than the conventional thermodynamic inhibitors.

While kinetic inhibitors act by slowing down the kinetics of the nucleation, anti-agglomerants prevent the agglomeration (self adhesion) of gas hydrate crystals. Kinetic inhibitors are usually synthetic polymers or copolymers, while anti-agglomerants are often quaternary ammonium compounds (R₁R₂R₃R₄N⁺A⁻ where all of R₁, R₂, R₃ and R₄ are organic radicals and A⁻ is an anion) having surface active properties. U.S. Pat. No. 5,460,728 and U.S. Pat. No. 5,648,575 (Shell Oil Company, US) describes a method for inhibiting the formation of hydrates by addition to the stream of a quaternary ammonium compound or a trialkylamine salt (R₁R₂R₃HN⁺A⁻) where the Rₓ substituents are independently chosen from the group consisting of normal and branched alkyls having at least 4 carbon atoms. More quaternary ammonium compounds and trialkyl amine salts with various substituents are described in many later patents, such as in U.S. Pat. No. 6,214,091 (Shell Oil Company, US), U.S. Pat. No. 8,034,748 (Clariant Produkte, DE), U.S. Pat. No. 6,595,911 (Baker Hughes Inc., US). Among the known LDHIs, quaternary ammonium halides, and quaternary ammonium chlorides in particular, have many advantages: they perform well at very low dosages and may be prepared from largely available, highly reactive, low cost, versatile raw materials, such as alkyl and alkenyl chlorides. By way of example, very effective quaternary ammonium chlorides that are useful as gas hydrate inhibitors are advantageously synthesized from tertiary amines by quaternization with allyl chloride. The resulting N-propenyl quaternary ammonium chlorides, typically also comprise at least one fatty alkyl, fatty alkyl ether or fatty hydroxy substituted alkyl ether chain and have noticeably additional properties beside being effective as LDHI, preventing the self-agglomeration of forming hydrate crystals and their adhesion to the conduits walls. Unfortunately, quaternary ammonium chlorides have some drawbacks too.

Quaternary ammonium chlorides undergo thermal decomposition. Two types of decomposition reactions usually take place simultaneously: the removal of one of the N-alk(en)yl groups as an alk(en)yl halide with formation of tertiary amines, and elimination of hydrogen chloride through extraction of an hydrogen atom from one of the N-alk(en)yl groups with formation of mixture of tertiary amine chloride salts and olefin. Although tertiary amine salts have been described as being effective as LDHI too, the unselective thermal decomposition often leads to low performing mixtures of compounds.

Moreover, chloride ions and even organic chlorides are potentially damaging to refinery because they may lead to the formation of hydrochloric acid in hydrotreating or reforming reactors and to its accumulation in condensing zones of the refinery.

The absence or reduction of halide ions and organic halides in additives that are used at producing sites, pipelines or tanks is therefore highly desirable in order to mitigate corrosion problems in refinery processes. This problem has been known for a long time and was addressed by way of example by U.S. 2012/0078021 (Multi-Chem Group, LLC) where anti-agglomerate gas hydrate inhibitors that do not contain residual halides in sufficient quantities to present risk of corrosion are described. The gas hydrate inhibitors of U.S. 2012/0078021 are amine salts obtained from the reaction of non-halide containing inorganic acids and/or organic acids and organic amines. An alternative to quaternary ammonium chlorides has also been proposed by WO 2012/102916 (Baker Hughes Inc. US), in which organic and inorganic tertiary amine salts for use as gas hydrate inhibitors are disclosed. Due to the fact that N-propenyl quaternary ammonium chlorides comprising at least one fatty chain have demonstrated to be very effective as LDHI, it would also be highly desirable to provide, through a convenient synthetic route, LDHIs that maintain unchanged this efficient organic cationic portion, beside reducing or eliminating halide ions and organic halides. It has know been found that non-corrosive quaternary ammonium compounds that are very effective as gas hydrate inhibitors may conveniently be prepared from the corresponding quaternary ammonium halides without altering their organic cationic portion.

### SUMMARY OF THE INVENTION

Accordingly, quaternary ammonium halides, and in particular quaternary ammonium chlorides, are reacted with a metal hydroxide, or with a metal salt MA, to form the corresponding quaternary ammonium hydroxides, or quaternary ammonium compound QA, and metal halide, the metal halide is separated and, optionally, the quaternary ammonium hydroxides is reacted with an organic or inorganic acid to form a non corrosive, quaternary ammonium compounds.

Both the intermediate quaternary ammonium hydroxides and the non corrosive, quaternary ammonium compounds QA may be used as such for inhibiting the formation of hydrocarbon hydrates.

The present disclosure thus relates to a method for inhibiting the formation of hydrocarbon hydrates comprising contacting a fluid including a mixture comprising water and hydrate-forming guest molecules at gas hydrate forming conditions with a quaternary ammonium hydroxide QOH or a quaternary ammonium compound QA, in which A is not a halogen atom, prepared by the following steps:
i. a quaternary ammonium halide QX is reacted with a metal hydroxide M(OH)ₓ, or with a metal salt MA, in a solvent comprising an alcohol, to form a quaternary ammonium hydroxide QOH, or a quaternary ammonium compound QA, and metal halide MX;
ii. optionally, the quaternary ammonium hydroxide QOH is reacted with an organic or inorganic acid AH which is different from a hydrogen halide to form the quaternary ammonium compound QA;
iii. the metal halide MX is removed from the reaction mixture deriving from i. or from ii. by phase separation after addition of water or of a water/solvent mixture, or by filtration.

### DETAILED DESCRIPTION

The method for inhibiting the formation of hydrocarbon hydrates of the present disclosure preferably uses quaternary ammonium compound in which Q has formula R₁R₂R₃R₄N⁺ where R₁, R₂, R₃, R₄ are, each independently, linear or branched, substituted or unsubstituted, C₃-C₂₅ alkyl, alkenyl or alkyl ether groups, or substituted or unsubstituted aryl groups.

More preferably at least two of R₁, R₂, R₃, R₄ are linear or branched, substituted or unsubstituted, C₃-C₆ alkyl groups, one of R₁, R₂, R₃, R₄ is a propenyl group and one of R₁, R₂, R₃, R₄ is a propyl ether group where the C2 bears a —OH group and the C3 bears a linear or branched, substituted or unsubstituted, C₄-C₂₂ alkyloxy group.

Most preferably two of R₁, R₂, R₃, R₄ are butyl groups, one of R₁, R₂, R₃, R₄ is a propenyl group, and one of R₁, R₂, R₃, R₄ is a propyl ether group where the C3 bears a linear C₁₂₋₁₄ alkyloxy group. According to a preferred embodiment in step i. the quaternary ammonium halide QX is reacted with a metal hydroxide M(OH)ₓ

In this embodiment, step i. may be carried out according to the method described in U.S. Pat. No. 5,760,088 (Lonza Inc., US) for the preparation of wood preservative systems comprising quaternary ammonium compounds (that are typically dimethyl di-fatty alkyl- and trimethyl fatty alkyl-ammonium compounds).

In one preferred embodiment, the starting quaternary ammonium halide is a quaternary ammonium chloride and the metal halide which is formed in step i. is a metal chloride.

The metal of the metal hydroxide of step i. is a mono-, bi-, or trivalent metal; preferably the metal hydroxide is an alkali metal hydroxide such as sodium hydroxide or potassium hydroxide, potassium hydroxide being the most preferred metal hydroxide.

The amount of metal hydroxide to be used in step i. is a stoichiometric amount with respect to the quaternary ammonium chloride reactant. A stoichiometric excess of metal hydroxide ranging from about 2% to about 20% excess may also be used to increase the yield, as it is suggested in U.S. Pat. No. 5,760,088.

According to another embodiment, in step i. the quaternary ammonium halide QX is reacted with a metal salt MA, in which the anion is not a halide anion.

The metal of the metal salt MA of step i. is a mono-, bi-, or trivalent metal; preferably the metal is an alkali metal, such as sodium or potassium. In principle, the metal salt MA may be the salt of any organic or inorganic acid (AH). Metal salts from mixture of organic and inorganic acid may also be used. Preferred metal salts from organic acid salts are metal salts of carboxylic acids, such as glycolic acid, acetic acid, formic acid, benzoic acid, lactic acid, stearic acid, oxalic acid, and the like. Metal salts from di- and poly-carboxylic acids, such as succinic acid, maleic acid, citric acid, phthalic acid, adipic acid, and from organic sulfonic acids, such as methane sulfonic acid and toluenesulfonic acid, may also be used.

Preferred metal salts from inorganic acids are the partial or total salts of carbonic acid (CO₂), phosphoric acid, sulfuric acid, nitric acid.

According to this embodiment, preferably in step i. the quaternary ammonium hydroxide QOH is reacted with an alkali metal salt of CO₂, formic acid, acetic acid or oxalic acid, more preferably with anhydrous potassium acetate. Step i. is typically performed at 20-80° C. for 1-5 hours, under stirring. The metal halide formed in step i. precipitates and may be easily removed directly after step i., i.e. by filtration or the like, yielding a quaternary ammonium hydroxide dissolved in the solvent that has been used to carry out the reaction of step i., which is preferably methanol, ethanol, n-propanol, isopropanol, n-butanol, isobutanol, t-butanol, or mixture thereof.

Alternatively, the metal chloride formed in step i. may be removed from the solution of quaternary ammonium hydroxide by adding water and separating the aqueous solution which is formed and contains most of the metal chloride which is present in the reaction mixture.

The quaternary ammonium hydroxide which may be obtained from step i. is a very strong base that may decompose both oxidatively and thermally through Hofmann elimination, that originates tertiary amine, water and olefin. As a consequence, although quaternary ammonium hydroxides are reported to perform as gas hydrate inhibitors too, it is preferable to neutralize them in order to obtain the non corrosive, quaternary ammonium compounds Q⁺A⁻ that may be used as such for inhibiting the formation of hydrocarbon hydrates.

According to U.S. Pat. No. 5,438,034 (Lonza Inc., US) dialkyldimethyl ammonium carbonates or bicarbonates may be obtained from the corresponding hydroxides and may be used for preserving wood substrates.

Analogously, the quaternary ammonium hydroxide Q⁺OH⁻ may be reacted with an organic or inorganic acid AH, which is different from a hydrogen halide, to form a quaternary ammonium compound Q⁺A⁻ (step ii.) Step ii. may be performed after having removed the metal halide or directly on the heterogeneous mixture which is obtained from step i. In principle any organic or inorganic acid may be used in step ii. Mixture of organic and inorganic acids may also be used. Preferred organic acids are carboxylic acids, such as glycolic acid, acetic acid, formic acid, benzoic acid, lactic acid, stearic acid, oxalic acid, and the like. Di- and poly-carboxylic acids, such as succinic acid, maleic acid, citric acid, phthalic acid, adipic acid, and organic sulfonic acids, such as methanesulfonic acid and toluenesulfonic acid, may also be used.

Preferred inorganic acids are carbonic acid (CO₂), phosphoric acid, sulfuric acid, nitric acid. According to a preferred embodiment in step ii. the quaternary ammonium hydroxide Q⁺OH⁻ is reacted with an acid selected among CO₂, formic acid, acetic acid and oxalic acid. The reaction of step ii. takes place at 20-50° C. for 30 min.-2 hours, under stirring.

A stoichiometric amount of acid (that considers the possible excess of metal hydroxide used in step i.) is generally used. A stoichiometric excess of acid ranging from about 2% to about 20% excess may also be used to increase the yield.

In case the acid(s) is added in the heterogeneous mixture resulting from step i., the removal of the metal halide which is formed in step I, and the possible salts deriving from the excess of metal hydroxide of step i. may be filtered in a single final step iii. by filtration.

The metal halide MX and additional salts may also be removed from the reaction mixture deriving from i. or from ii. by phase separation after addition of water.

Advantageously, in case the separation of the metal halide is performed by phase separation, addition after step ii. of a water immiscible solvent, such as xylene, and water may help the solubilization of the quaternary ammonium compound in the organic phase and removal of the inorganic undesired salt in the aqueous phase.

### EXAMPLES

The following examples illustrate the invention without limitation. All parts and percentage are given by weight unless otherwise indicated.

### Example 1

150 grams (0.254 mol) of a 90% quaternary ammonium chloride of formula R₁R₂R₃R₄N⁺Cl⁻ in which R₁ and R₂ are butyl, R₃ is allyl and R₄ is 2-hydroxy-3-C₁₂₋₁₄alkoxypropyl (DBAAPC) in 10% isopropanol (135 grams of quaternary ammonium halide), 120 mL of anhydrous ethanol and 21 grams (0.32 mol) of 85% potassium hydroxide pellets (18 grams of KOH) were mixed in a flask that was purged with nitrogen and equipped with a heating mantle and magnetic stirrer. The mixture was stirred and heated at 60-70° C. for two hours. The mixture was then allowed to cool to room temperature and finally cooled to 5° C.

Potassium chloride precipitated and the precipitate was collected on vacuum filter. The solid was washed with cold ethanol and subsequently was dried, yielding 21 grams (calculated yield 19 grams) of dry potassium chloride. The filtrate was a yellow liquid containing the quaternary ammonium hydroxide and less than 0.1% quaternary ammonium chloride.

### Example 2

150 grams (0.254 mol) of 90% DBAAPC in 10% isopropanol (135 grams of quaternary ammonium halide), 120 mL of anhydrous ethanol and 21 grams (0.32 mol) of 85% potassium hydroxide pellets (18 grams of KOH) were mixed in a flask that was purged with nitrogen and equipped with a heating mantle and magnetic stirrer. The mixture was stirred and heated at 60°-70° C. for two hours. The mixture was then allowed to cool to room temperature and finally cooled to 5° C.

Potassium chloride precipitated and the precipitate was collected on vacuum filter. The solid was washed with cold ethanol and subsequently was dried, yielding 21 grams (calculated yield 19 grams) of dry potassium chloride.

The ethanolic solution of quaternary ammonium hydroxide containing about 0.066 mol of unreacted KOH, was stirred while carbon dioxide was bubbled over one hour. The resultant mixture was then filtered to remove 5.2 grams of potassium carbonate (4.5 grams calculated) yielding a yellow liquid containing the quaternary ammonium carbonate and less than 0.1% quaternary ammonium chloride.

### Example 3

150 grams (0.254 mol) of 90% DBAAPC in 10% isopropanol (135 grams of quaternary ammonium halide), 120 mL of anhydrous ethanol and 21 grams (0.32 mol) of 85% potassium hydroxide pellets (18 grams of KOH) were mixed in a flask that was purged with nitrogen and equipped with a heating mantle and magnetic stirrer. The mixture was stirred and heated at 50° C. for one hour.

Potassium chloride precipitated and the precipitate was collected on vacuum filter. The solid was washed with cold ethanol and subsequently was dried, yielding 21 grams (calculated yield 19 grams) of dry potassium chloride.

The ethanolic solution of quaternary ammonium hydroxide containing about 0.066 mol of unreacted KOH, was stirred while carbon dioxide was bubbled over one hour. The resultant mixture was then filtered yielding a yellow liquid.

### Example 4

150 grams (0.254 mol) of 90% DBAAPC in 10% isopropanol (135 grams of quaternary ammonium halide), 120 mL of anhydrous ethanol and 21 grams (0.32 mol) of 85% potassium hydroxide pellets (18 grams of KOH) were mixed in a flask that was purged with nitrogen and equipped with a heating mantle and magnetic stirrer. The mixture was stirred and heated at 25° C. for one hour.

Potassium chloride precipitated and the precipitate was collected on vacuum filter. The solid was washed with cold ethanol and subsequently was dried, yielding 21 grams (calculated yield 19 grams) of dry potassium chloride.

The ethanolic solution of quaternary ammonium hydroxide containing about 0.066 mol of unreacted KOH, was stirred while carbon dioxide was bubbled over one hour. The resultant mixture was then filtered yielding a yellow liquid.

### Example 5

The procedure of Example 2 is followed, substituting 120 mL of ethanol for methanol.

### Example 6

The procedure of Example 2 is followed, substituting 120 mL of ethanol for isopropanol.

### Example 7

The procedure of Example 2 is followed, substituting 120 mL of ethanol for n-propanol.

### Example 8

The procedure of Example 2 is followed, substituting 0.32 mole of KOH for NaOH.

### Example 9

150 grams (0.254 mol) of 90% DBAAPC in 10% isopropanol (135 grams of quaternary ammonium halide), 120 mL of anhydrous ethanol and 21 grams (0.32 mol) of 85% potassium hydroxide pellets (18 grams of KOH) were mixed in a flask that was purged with nitrogen and equipped with a heating mantle and magnetic stirrer. The mixture was stirred and heated at 60°-70° C. for two hours. The mixture was then allowed to cool to room temperature and finally cooled to 5° C.

Potassium chloride precipitated and the precipitate was collected on vacuum filter. The solid was washed with cold ethanol and subsequently was dried, yielding 21 grams (calculated yield 19 grams) of dry potassium chloride.

The ethanolic solution of quaternary ammonium hydroxide containing about 0.066 mol of unreacted KOH, was mixed with a stoichiometric amount (0.32 mol, 17.33 g) of formic acid 85% and stirred at 50° C. for 2 hours. The resultant mixture was then filtered to yield a yellow liquid.

### Example 10

The procedure of Example 9 is followed, substituting formic acid for acetic acid.

### Example 11

The procedure of Example 9 is followed, substituting formic acid for nitric acid.

### Example 12

The procedure of Example 9 is followed, substituting formic acid for sulfuric acid.

### Example 13

150 grams (0.254 mol) of 90% DBAAPC in 10% isopropanol (135 grams of quaternary ammonium halide), 120 mL of anhydrous isopropanol and 21 grams (0.32 mol) of 85% potassium hydroxide pellets (18 grams of KOH) were mixed in a flask that was purged with nitrogen and equipped with a heating mantle and magnetic stirrer. The mixture was stirred and heated at 60°-70° C. for two hours. The mixture was then allowed to cool to room temperature and finally cooled to 5° C.

The solution of quaternary ammonium hydroxide containing about 0.066 mol of unreacted KOH, was mixed with a stoichiometric amount (0.32 mol, 17.33 g) of formic acid 85% and stirred at 50° C. for 2 hours. The mixture was washed with 35 grams of water dissolving the precipitate and the aqueous phase separated using a separatory funnel. The organic phase was collected to yield a yellow liquid.

### Example 14

The procedure of Example 13 is followed, substituting formic acid for acetic acid.

### Example 15

The procedure of Example 13 is followed, substituting formic acid for nitric acid.

### Example 16

The procedure of Example 13 is followed, substituting formic acid for sulfuric acid.

### Example 17

150 grams (0.254 mol) of 90% DBAAPC in 10% isopropanol (135 grams of quaternary ammonium halide), 120 mL of anhydrous ethanol, and a stoichiometric excess (31 grams, 0.32 mol) of anhydrous potassium acetate were mixed in a flask that was purged with nitrogen and equipped with a heating mantle and magnetic stirrer, and a condenser. The mixture was stirred and heated at 60°-70° C. for two hours. The insoluble potassium acetate crystals slowly dissolved and a fine solid (KCl) separated. The mixture was then cooled to 5° C. and vacuum filtered to yield a yellow liquid.

1. A method for inhibiting the formation of hydrocarbon hydrates comprising contacting a fluid including a mixture comprising water and hydrate-forming guest molecules at gas hydrate forming conditions with a quaternary ammonium hydroxide QOH or a quaternary ammonium compound QA, in which A is not a halogen atom, prepared by the following steps:
i. a quaternary ammonium halide QX is reacted with a metal hydroxide M(OH)ₓ, or with a metal salt MA, in a solvent comprising an alcohol, to form a quaternary ammonium hydroxide QOH, or a quaternary ammonium compound of formula QA, and metal halide MX;
ii. optionally, the quaternary ammonium hydroxide QOH is reacted with an organic or inorganic acid AH which is different from a hydrogen halide to form the quaternary ammonium compound QA;
the metal halide MX is removed from the reaction mixture deriving from i. or from ii. by phase separation after addition of water or of a water/solvent mixture, or by filtration.

2. The method for inhibiting the formation of hydrocarbon hydrates of claim 1 in which the quaternary ammonium halide is a quaternary ammonium chloride and metal chloride is formed and removed from the reaction mixture deriving from i. or from ii.

3. The method for inhibiting the formation of hydrocarbon hydrates of claim 1 in which in the quaternary ammonium compound Q has formula R₁R₂R₃R₄N⁺ in which R₁, R₂, R₃, R₄ are, each independently, linear or branched, substituted or unsubstituted, C₃-C₂₅ alkyl, alkenyl or alkyl ether groups, or substituted or unsubstituted aryl groups.

4. The method for inhibiting the formation of hydrocarbon hydrates of claim 3 in which at least two of R₁, R₂, R₃, R₄ are linear or branched, substituted or unsubstituted, C₃-C₆ alkyl groups, one of R₁, R₂, R₃, R₄ is a propenyl group and one of R₁, R₂, R₃, R₄ is a propyl ether group where the C2 bears a —OH group and the C3 bears a linear or branched, substituted or unsubstituted, C₄-C₁₈ alkyloxy group.

5. The method for inhibiting the formation of hydrocarbon hydrates of claim 4 in which two of R₁, R₂, R₃, R₄ are butyl groups, one of R₁, R₂, R₃, R₄ is a propenyl group, and one of R₁, R₂, R₃, R₄ is a propyl ether group where the C3 bears a linear C₁₂₋₁₄ alkyloxy group.

6. The method for inhibiting the formation of hydrocarbon hydrates of claim 1 in which in step i. the metal hydroxide is KOH or NaOH and the solvent is methanol, ethanol, n-propanol or isopropanol.

7. The method for inhibiting the formation of hydrocarbon hydrates of claim 6 in which in step i. the metal hydroxide is KOH and the solvent is isopropanol.

8. The method for inhibiting the formation of hydrocarbon hydrates of claim 1 in which the metal halide MX is removed from the reaction mixture deriving from i. or from ii. by filtration.

9. The method for inhibiting the formation of hydrocarbon hydrates of claim 1 in which the metal halide MX is removed from the reaction mixture deriving from i. or from ii. by phase separation after addition of water.

10. The method for inhibiting the formation of hydrocarbon hydrates of claim 1 in which the metal halide MX is removed from the reaction mixture deriving from i. or from ii. by phase separation after addition of a water/water immiscible solvent mixture.
